(19) United States
(12) Patent Application Publication
(10) Pub. No.: US 2012/0279101 A1
(43) Pub. Date: Nov. 8, 2012

(54) SECURITY LABEL FOR IDENTIFYING PRODUCTS

(76) Inventors: Thorsten Pretsch, Berlin (DE); Werner Mueller, Berlin (DE)

(21) Appl. No.: 13/510,559

(22) PCT Filed: Jul. 27, 2010
(86) PCT No.: PCT/EP10/60913

§ 371 Date: Jul. 24, 2012

Related U.S. Application Data
(60) Provisional application No. 61/262,167, filed on Nov. 18, 2009.

(30) Foreign Application Priority Data
Nov. 18, 2009 (DE) 102009053808.9

(51) Int. Cl. G09F 3/02; B29C 59/02

(52) U.S. Cl. 40/299.01; 264/230

(57) ABSTRACT

The invention relates to a security label for identifying products comprising a layer comprising a shape memory polymer, wherein a surface profile comprising information for identifying the product is embossed in the layer and wherein the layer has a smooth surface in a first state and the layer has the embossed surface profile in a second state, wherein the security label is adapted such that the layer can be changed from the first or second state to the second or first state upon reading out the security label and to a connection means for connecting the layer to the product.

The present invention relates to a security label for identifying products and use thereof. Other aspects of the invention relate to manufacturing processes for such a security label and readout processes for such a security label.

Nowadays, there is hardly a branch of industry that is not affected by product piracy. Product piracy is extremely prevalent particularly in the field of products whose value is determined to a large degree by their visual appeal, design and an especially high level of craftsmanship, for example clothing. Businesses are suffering immensely from this trend. According to estimates by the Ministry of Justice, in Germany alone about 50,000 jobs are lost every year due to product piracy. In Europe as a whole, the number of jobs lost in this way is thought to be as high as 300,000.

More and more often, product piracy is being combated with protection technologies in the form of technical security means. Such security means include for example holograms, security labels (VOID films, document films), microcolour codes, digital watermarks, copy detection and datamatrix, DNA or nanotechnologies, and RFID.

However, many of these technologies are expensive and complicated, both in terms of their manufacture and with regard to their use for verifying authenticity. For example, a hologram is both expensive and complicated to make. Holograms cannot be recorded unless the interference patterns formed by superimposing the wave fields are stable both temporally and spatially. The objects to be recorded must not move at all for the entire exposure time, which sometimes last several minutes. Therefore, in order to record a hologram the parts of the recording apparatus and the object must be fixed immovably. Usually, the entire holographic structure, or at least parts of it, is mounted on a vibration free table. Such a table is very heavy, often made from several tons of concrete or heavy slabs, and is supported on mechanical or pneumatically damped feet. First, a prototype is generated from a photosensitive material with laser beams. But this template is too soft to be used to emboss holograms in plastic for example. This is why the filigree relief is copied to a harder material such as nickel. When attached to a roller, this nickel template transfers the hologram to a plastic film. However, the disadvantage of nickel is that it is relatively soft and is worn down quickly. Consequently, many such embossing templates are needed when producing holograms in large numbers.

In view of the above, the present invention suggests a security label as recited in claim 1 or 5, a product as recited in claim 13, a use as recited in claim 14, production methods as recited in claims 15, 16 and 18, and readout methods as recited in claims 17 and 19. Other features, advantages and particularities of the present invention are described in the subordinate claims, the description and the accompanying drawings.

According to one embodiment, a security label for identifying a product includes a layer with a shape memory polymer, wherein in a first state the layer has a first surface profile containing information for identifying the product, and wherein the layer may assume at least a second state, wherein in the second state the layer has a second surface profile differing from the first surface profile, and the security label is adapted in such manner that the layer may be switched from the second state to the first state for reading out the security label, and a joining means for bonding the layer to the product. For example, the first surface profile may be the permanent shape of the shape memory polymer layer. According to one embodiment, the second surface profile is generated by programming the shape memory polymer layer. In this context, the second surface profile may be a flat surface, for example. According to a further refinement, however, the second surface profile may also be structured but it may have a shape that is different from that of the first surface profile.

According to one embodiment, a security label for identifying a product includes a layer having a shape memory polymer. A surface profile containing information for identifying the produce is imprinted in the layer. The layer may assume at least a first and a second state, wherein the layer has a flat surface in the first state and has the embossed surface profile in the second state. The security label is also adapted in such manner that the layer is switchable from the first state to the second state when the security label is read out. The security label is also furnished with a bonding agent for the purpose of bonding the layer to the product.

In order to check the authenticity of a product, for example an article of clothing, a bottle of wine, a watch, a medication, a brand item and so on, the product with the described security label, hereinafter also called the label, may be specifically identified with a shape memory polymer (SMP). The plastic part or the plastic foil that encompasses the SMP may be integrated unobtrusively in the product in a variety of ways. Initially, it does not show any special information, because it is in the first state, with a flat surface. However, the SMP has already been subjected one or more programming processes in advance. In this way, specific information about the product to be protected is hidden in its shape memory. If one or more shape memory effects are called up layer by applying external stimuli (heating, application of a magnetic field or the like), this information is revealed. This information may then be used to prove the authenticity of the marked product.

A counterfeiter who might wish to imitate such a security label would then have to solve several problems. First he must gain knowledge about the new security technology in sufficient detail to enable him to imitate the security labels. He would then have to obtain the very special materials that were used to make the security label. He would have to be in possession of the special information that is hidden in the shape memory of the material. He would also have to have access to the programming technology. Counterfeiting would be impossible without a thorough knowledge of the thermomechanical properties of SMPs with two-shape or three-shape memory, including their programming. In all, counterfeiting this security label would be associated with very substantial difficulties. At the same time, the process of reading out the shape memory effect and thus revealing the hidden information may be designed so simply that a retailer would be able to verify the authenticity of the product himself in his shop.

According to a refinement, a second surface profile may also be embossed in the layer, wherein a third state of the layer contains the embossed second surface profile. The security label is then adapted in such manner that the layer may be brought into the third state from the first state when the security label is read out.

When three-shape memory SMPs are used, three different surface shapes can be stored in the layer, and two of these shapes can hold information. In this respect, invulnerability to counterfeiting is also increased relative to the “simpler” security labels with a two-shape memory.

According to another refinement, the security label may be configured in such manner that the layer may be returned to the first state from the second and/or the third state.

With the aid of two-way SMPs, the security label may be switched between the “flat” starting state and the programmed surface profile as often as desired. This enables the security label to be read out multiple times at different stages in the retail chain or by customs when the goods are imported.

According to one embodiment, the layer has a thickness in the range from 0.1 mm to 20 mm.

Embodiments of the present invention include a shape memory polymer selected from the group that includes: linear block copolymers, particularly polyurethanes and polyurethanes with ionic or mesogenic components, block copolymers of polyethylene terephthalate and polyethylene oxide, block copolymers of polystyrene and poly(1,4-butadiene), ABA triblock copolymers of poly-(2-methyl-2-oxazolin) (A block) and polytetrahydrofuran (B block), multiblock copolymers of polyurethanes with poly(E-caprolactone) switching segment, block copolymers of polyethylene terephthalate and polyethylene oxide, block copolymers of polystyrene and poly(1,4-butadiene), polyurethane systems whose hard segment forming phase consists of methylenediphenyl diisocyanate (MDI) and a diol, particularly 1,4-butanediol, or a diamine and a switching segment with oligoether base, particularly polytetrahydrofuran or an oligoester, particularly polyethylene adipate, polypropylene adipate, polybutylene adipate, polypentylene adipate or polyhexalene adipate, materials with a hard segment forming phase consisting of toluene-2,4-diisocyanate, MDI, diisocyanates constructed particularly from MDI or hexamethylene diisocyanate in carbodiimide-modified form, and from chain extenders, particularly ethylene glycol, bis(2-hydroxyethyl)hydroquinone or a combination of 2,2-bis(4-hydroxyphenyl)propane and ethylene oxide, whose switching segment determining blocks consist of oligoethers, particularly polyethylene oxide, polypropylene oxide, polytetrahydrofuran or a combination of 2,2-bis(4-hydroxyphenyl)propane and propylene oxide, or oligoesters, particularly polybutylene adipate, materials from polynorbornene, graft copolymers of polyethylene/nylon-6, block copolymers with polyhedral oligomeric silsesquioxanes (POSS), including the combinations polyurethane/POSS, epoxy/POSS, polysiloxane/POSS, polymethyl methacrylate/POSS, silicone-based SMPs and materials made from poly(cyclooctene)E-caprolactone.

Further embodiments of the present invention include a shape memory polymer selected from the group consisting of: polyvinyl chloride, polyethylene-polyvinyl acetate copolymers, covalently crosslinked copolymer systems of stearyl acrylate and esters of methacrylic acid, trans-polyisoprene/polyurethane-based, segregated FGP, poly(ether ester) such as polyethylene oxide)/poly(ethylene terephthalate) copolymers, norbornyl/POSS copolymers, poly(methylene-1,3-cyclopentane) and copolymers thereof with polyethylene, styrene/butadiene copolymers, thiolene/acrylate copolymers, polynorbornene, polymer networks produced from poly(E-caprolactone) (PCL) and dimethacrylates, poly(E-caprolactone) (PCL)-based SMPs, acrylate-based SMPs, (meth)acrylate networks, crosslinked polyethylene, epoxy-based SMPs, a polyurethane/phenoxy blend, a polyurethane/polyvinyl chloride (PVC) blend.

Still other embodiments of the present invention comprise a shape memory polymer that is constructed as a shape memory polymer composite, wherein at least one filler material is embedded in the shape memory polymer matrix and is selected from the group that includes: magnetic nanoparticles, ferromagnetic particles, particularly AIN particles, Ni particles, Fe₂O₃ particles, Fe₃O₄ particles, NiZn particles, a nanoclay containing silicon nitride, silicon carbide, silicon dioxide, zirconium oxide and/or aluminium oxide, oligomeric silsesquioxanes, graphite particles, carbon nanotubes, synthetic fibres, particularly carbon fibres, glass fibres or Kevlar fibres, metal particles, thermochromic materials, particularly rutile, zinc oxide, 9,9′-bixanthylidene, 10,10′-bianthronylidene or bis-diethylammonium tetrachlorocuprate(II), and combinations of these filler materials. The filler materials may be used to adjust the mechanical, electrical, magnetic and/or visual properties of the SMP and adapt them to the intended use in each case. For example, bis-diethylammonium tetrachlorocuprate(II) undergoes a solid-solid phase conversion accompanied with a change in colour from green to yellow at about 53° C.

Security labels according to further embodiments of the present invention contain a shape memory polymer that is selected from the group consisting of: a poly(ester urethane) copolymer, a nematic liquid crystal elastomer, a photodeformation polymer. Such materials may particularly have a two-shape memory and a two-way effect.

The shape memory polymer may also be constructed as a thermo-sensitive and/or UV-sensitive and/or magnetosensitive and/or electroactive material. Optically controllable shape memory polymers comprise for example butyl acrylates that crosslink at their lateral chains via cinnamic acid groups under UV light of a certain wavelength and break the bond again when irradiated with another wavelength. Magnetically controllable shape memory polymers may be obtained for example by incorporating finely distributed magnetic nanoparticles of iron oxide for example in the plastic. Such materials are then capable of converting the energy of a magnetic field into heat. A desired temperature may be set precisely in the polymer by adjusting the fraction of nanoparticles and the strength of the magnetic field. Shape memory polymer composites with carbon nanotubes for example may be used as electroactive polymers (EAP). The aforementioned materials create various options for triggering the shape memory effect.

Polymers from the class of “perfluorosulphonic acid ionomers” (PFSA) are also suitable for use as shape memory polymers in embodiments of the present invention. PFSAs typically have a wide T_{g} range that may be between 55° C. and 130° C., for example. A two-, three- and even four-shape memory for example may be imposed on PFSAs by programming. Experiments by the inventors on a poly(ester urethane) show that at least four separate expansion resets are possible after programming. In some cases as many as six consecutive resets could be performed in the temperature range from −60° C. to room temperature.

Another aspect of the present invention relates to a product that is identified with a security label according to any of the embodiments.

According to a further aspect of the present invention, the use of a security label according to any of the embodiments to identify a product is included.

According to a further aspect of the present invention, a process for manufacturing a security label includes heating the shape memory polymer layer to above a switching temperature of the shape memory polymer, embossing a three-dimensional surface structure that contains the identifying information for the product into the shape memory polymer layer, and cooling the shape memory polymer layer to below a fixing temperature of the shape memory polymer to return the shape memory polymer layer to its first state.

According to another embodiment of the present invention, a manufacturing method for a security label includes the provision of a shape memory polymer layer that has a first and a second switching temperature, wherein the first switching temperature is higher than the second switching temperature, heating the shape memory polymer layer to a temperature above the first switching temperature of the shape memory polymer, embossing a first three-dimensional structure that contains first identifying information for a product into the shape memory polymer layer, cooling the shape memory polymer layer to below a first fixing temperature of the shape memory polymer, which is between the first and second switching temperatures, to fix the first surface structure, embossing a second three-dimensional surface structure that contains second identifying information for a product into the shape memory polymer layer at a temperature above the second switching temperature, and cooling the shape memory polymer layer to below a second fixing temperature of the shape memory polymer, which is lower than the second switching temperature, to fix the second surface structure.

According to a further aspect of the present invention, a read-out method for a security label includes providing a security label of the type described in the foregoing, heating the security label to above a switching temperature of the shape memory polymer so that the embossed, three-dimensional surface structure appears, and reading out the information relating to the product stored in the three-dimensional surface structure.

According to a further aspect of the present invention, a read-out method for a security label includes providing a security label of the type described in the foregoing, heating the security label to above a second switching temperature of the shape memory polymer so that an embossed second three-dimensional surface structure appears, reading out the information relating to the product stored in the second three-dimensional surface structure, heating the security label to above a first switching temperature of the shape memory polymer so that an embossed first three-dimensional surface structure appears, and reading out the information relating to the product stored in the first three-dimensional surface structure.

Other advantageous configurations, details, aspects and features of the present invention will be evident from the subordinate claims, the description and the accompanying drawing. In the drawing:

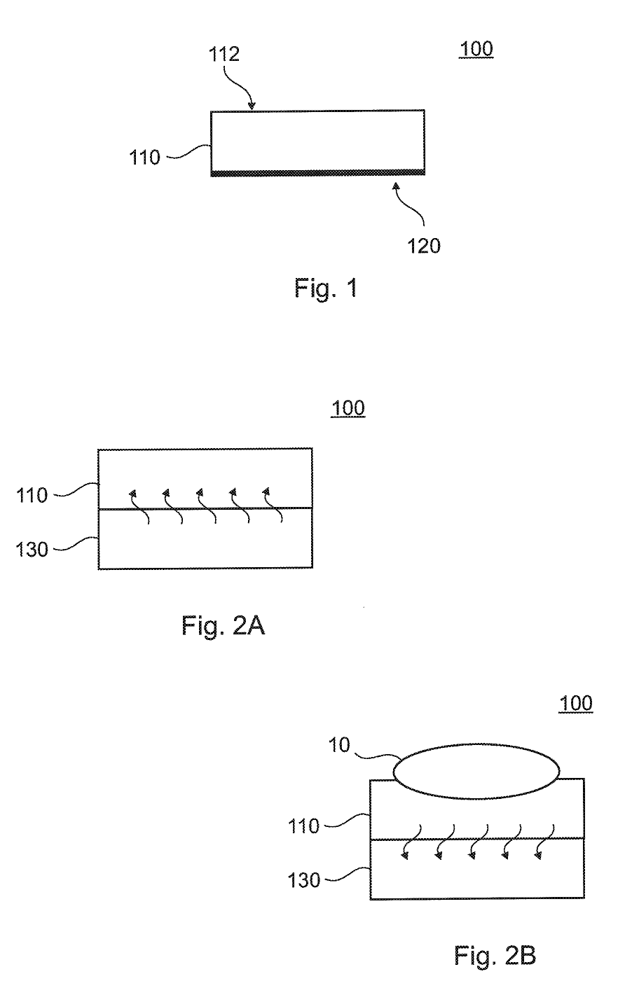

FIG. 1 shows a security label according to an embodiment of the present invention.

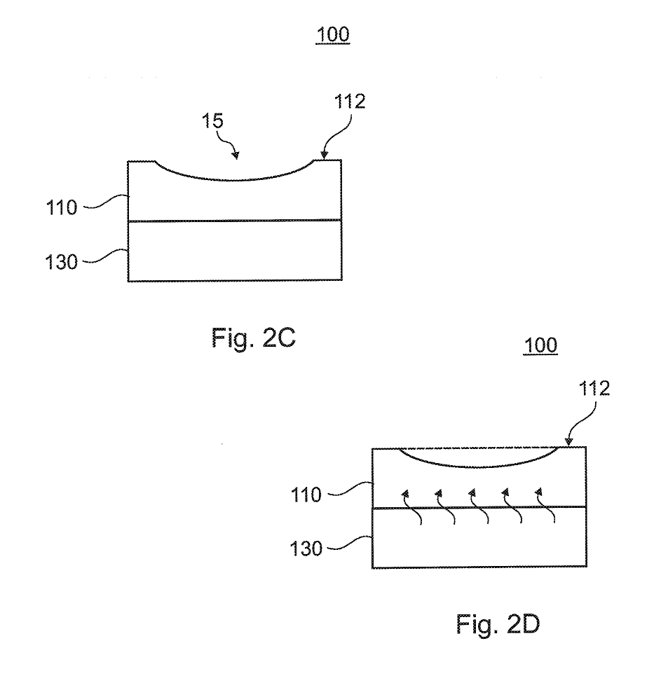

FIG. 2 shows various steps in carrying out the production method according to a first embodiment of the present invention.

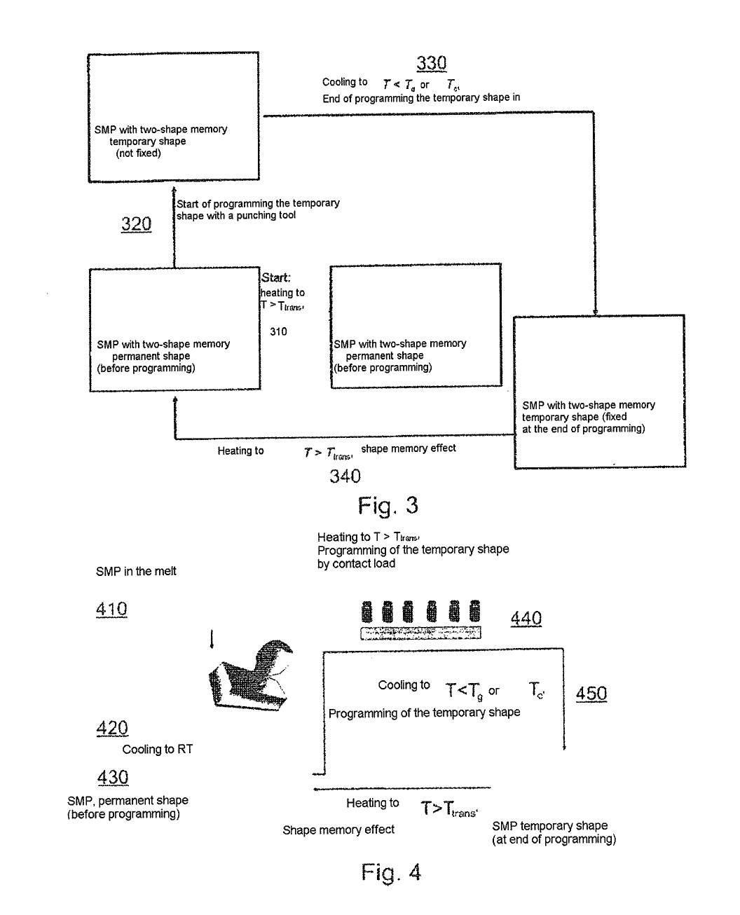

FIG. 3 shows a production method according to another embodiment of the present invention.

FIG. 4 shows a production and read-out method according to another embodiment of the present invention.

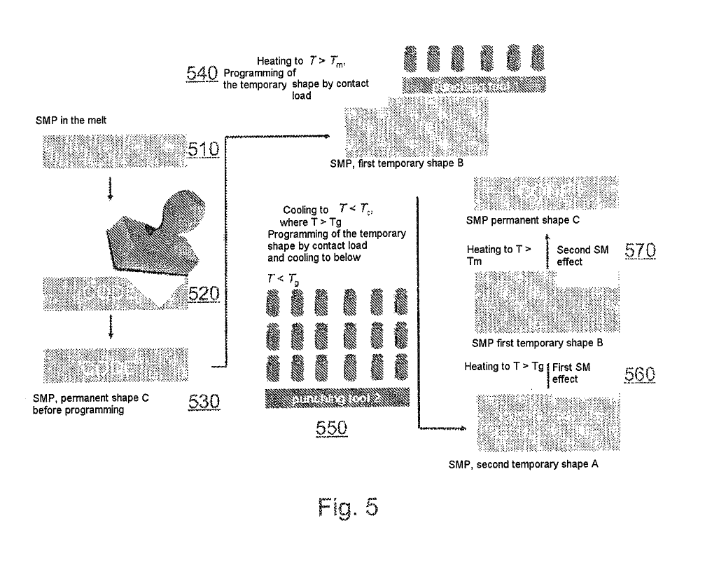

FIG. 5 shows a production and read-out method according to a further embodiment of the present invention.

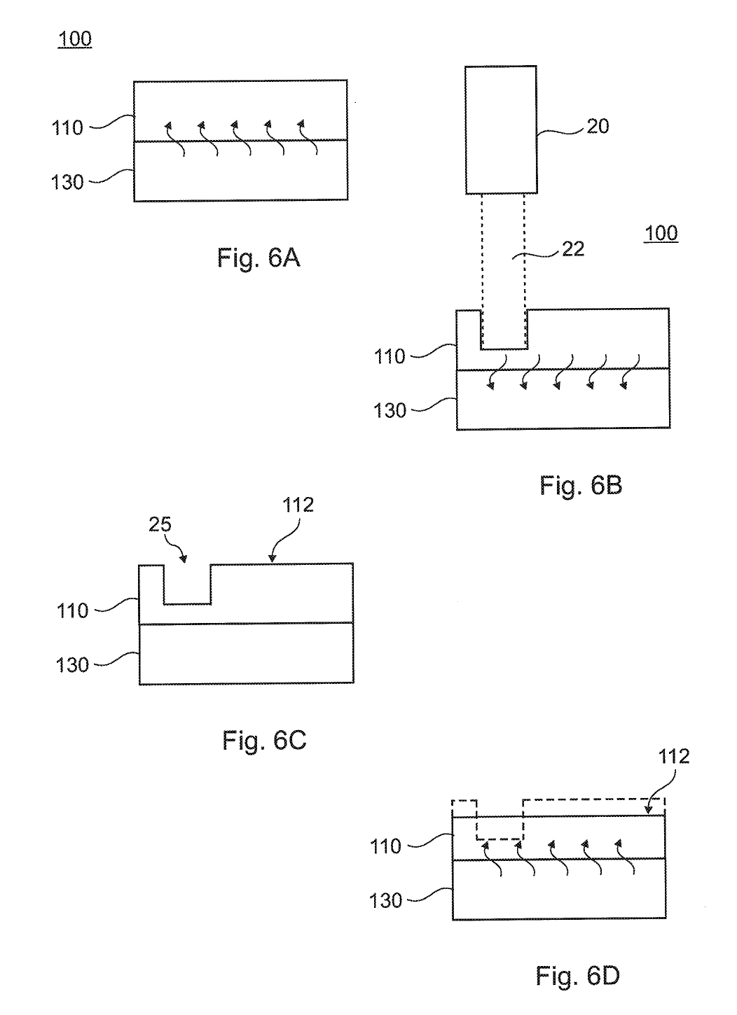

FIG. 6 shows various steps in carrying out a production method according to another embodiment of the present invention.

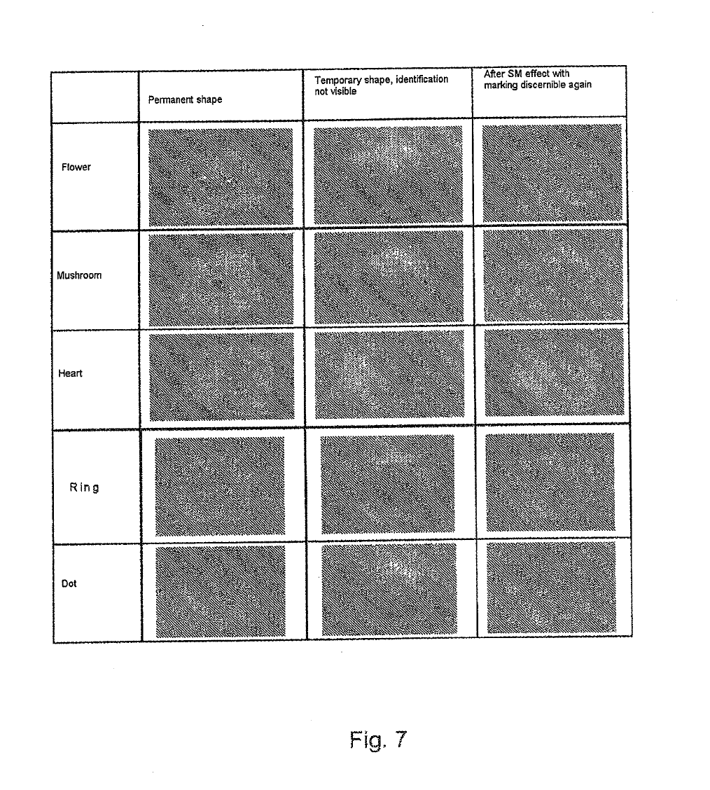

FIG. 7 shows image sequences of the surface of a thermosetting SMP after mechanical pretreatment (left, permanent shape), after programming (centre, temporary shape) and after heating (right, permanent shape).

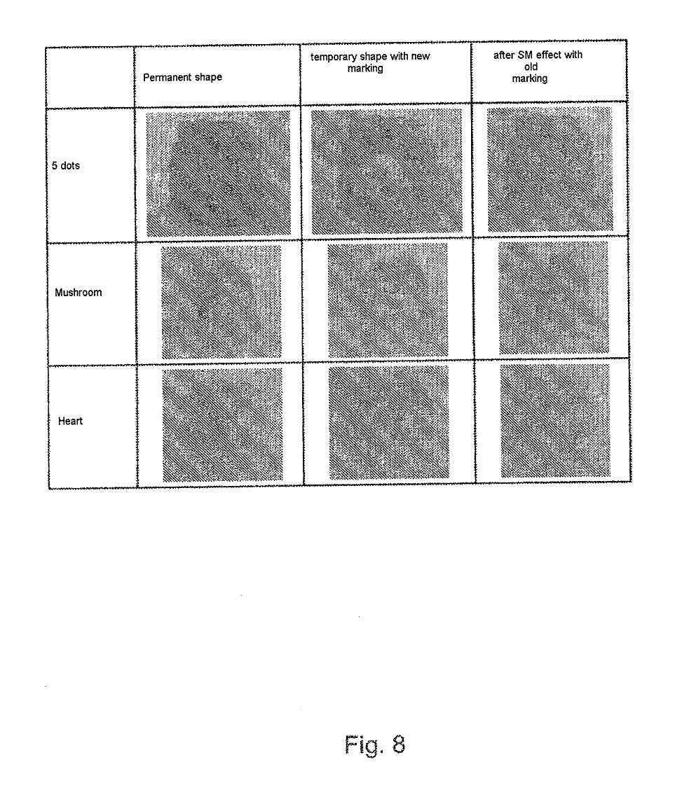

FIG. 8 shows representations of the surface of a thermosetting SMP after mechanical pretreatment (left, permanent shape), after programming with a 2-point punch (centre, temporary shape) and after heating (right, restored permanent shape).

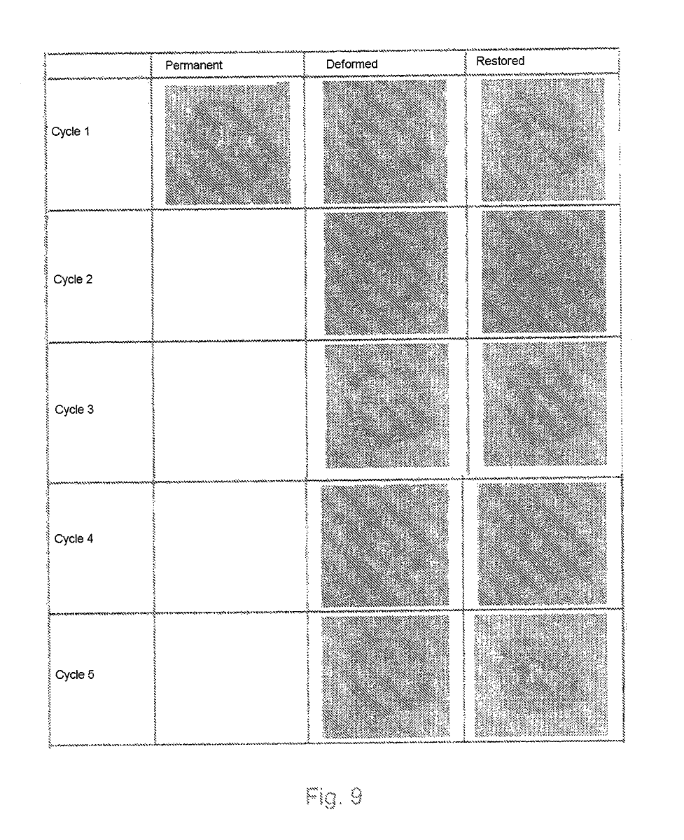

FIG. 9 is a representation of 5 consecutive cycles of the surface of a thermosetting SMP.

FIG. 1 shows a security label 100 according to an embodiment of the present invention. Security label 100 comprises a layer 110 that comprises a shape memory polymer. The term shape memory polymer (SMP) is generally used to refer to plastics that are able to “remember” their earlier external shape after a deformation and to this extent have a shape memory. For many SMPs, the return to the original shape is triggered when a “switching temperature” is exceeded. The thermosensitive SMPs may generally be divided into SMPs for which the switching temperature corresponds to a glass transition temperature (Tₜᵣₐₙₛ=T_{g}, and SMPs for which the switching temperature corresponds to the melting temperature of crystalline soft segments (Tₜᵣₐₙₛ=Tₘ). In the latter case, the SMPs have two components, the first component being an elastic polymer (hard segment) and the second component being a hardening wax (soft segment). When the SMP is deformed, the elastic polymer is “frozen” in its deformed shape by the hardened wax. When the SMP is heated afterwards, the wax softens and is no longer able to resist a restoring spring force of the elastic component. The SMP assumes its original shape again.

Now a surface profile that contains the information for identifying the product is embossed in layer 110. Three-dimensional surface structures may be embossed with relatively high resolution with the aid of a punching tool. Further programming steps enable previously embossed information to be decrypted. On this basis, the programmed SMP layer may be used to authenticate or identify objects by retrieving for example thermally induced shape memory transitions. The SMP label may also contain an optoelectronically readable script (barcode) that comprises parallel bars and gaps of varying widths. Alternatively or additionally, the surface profile may also contain a two-dimensional data matrix code. In particular, the data matrix code contains a high density of information per unit area of the SMP. In both cases, the SMP label may be marked directly either with a laser or using needle embossing. For SMPs with multiple shape memory, various code schemes may also be combined in a single SMP using SMP label technology.

In a first state, layer 110 has a flat surface 112. In a second state, surface 112 bears the embossed surface profile. Depending on the application, layer 112 is typically between 0.1 mm and 20 mm thick. In particular, the layer may have a thickness in the range from 1 mm to 5 mm, especially from 2 mm to 3 mm. Thicknesses in this range should be adequate for most applications insofar as they enable a surface structure to be embossed with profiles up to about 4 mm high. However, it is also possible to use thinner SMP foils, which can be attached by bonding or laminating.

Security label 100 is then adapted in such manner that layer 110 may be brought from the first state into the second state when the security label is read out. The security label is also furnished with an attachment means (120) for attaching the layer to a product. The attachment means may be for example an adhesive layer, as represented in FIG. 1. According to other embodiments, a border area of layer 110 or an additional area, or an additional layer may be provided as the attachment means, which is attachable to the product by bonding, sewing, welding or similar attachment methods.

Various shape memory polymers can be used for the security label. They may be classified for example according to whether the effect can only be created once (one-way effect) or whether it is reversible (two-way effect). The SMPs may also be classified according to whether they may be programmed with one or two further surface profiles besides their flat base structure (two-shape or three-shape memory).

According to one embodiment, the shape memory polymer of layer 110 is an SMP with one-way effect (“one-way shape memory polymer”) and two-shape (“dual-shape”) memory. These area SMP with a “one-way effect” for which the programming enables the shape memory effect to be evoked once, so that authenticity may be demonstrated once. In the case of SMP with one-way effect, however, a surface structure can be reprogrammed after it has been read out. In this way, SMPs with one-way effect may also be used multiple times.

According to another embodiment, the shape memory polymer of layer 110 is an SMP with two-way effect (“two-way shape memory polymers”) and dual-shape memory. These are SMPs with a “two-way effect” that are able to switch back and forth between two shapes, the “permanent” and the “temporary” shape, when certain external stimuli are applied, so that authenticity may be demonstrated any number of times.

According to yet another embodiment, the shape memory polymer of layer 110 is an SMP with one-way effect and triple shape memory (“triple-shape polymers”). These are SMPs into which two temporary shapes may be embossed and accordingly two shape changes may be evoked later by applying external stimuli. The advantage of SMPs with triple shape memory and one-way effect over SMPs with two-shape memory and one-way effect is that two individual shape changes may be evoked, which represents an information gain. Moreover, if one already knows the double-programmed base state, one can see whether the material has already undergone one or two shape changes.

Many known SMPs have a thermally induced shape memory effect. This means that the programmed polymer materials are heated above a defined transition temperature, a shape recovery caused by entropy elasticity takes place. Shape memory polymers are usually polymer networks in which the permanent shape is determined by chemical (covalent) or physical (non-covalent) crosslinking points. Phase-segregated, linear block copolymers are constructed from hard and soft segments. SMPs for which the switching temperature for recovering the shape is substantially higher than the transition temperature are suitable for use in security label 100. A further material requirement for the SMP consists in selecting the surface hardness such that the impressions created during the shape embossing processes are of sufficient precision.

Various shape memory polymers were tested in preliminary experiments and found to be viable for the described use in a security label. Materials tested for use as a shape memory included a thermoplastic poly(ester urethane) shape memory polymer manufactured by Bayer MaterialScience AG and a thermosetting shape memory polymer (Veriflex®) manufactured by CRG Industries, LLC, also a thermosetting epoxy-based SMP (Veriflex E2®).

Security labels such as the embodiments of the present invention may include a thermoplastic shape memory polymer, particularly from the group of linear block copolymers, particularly polyurethanes and polyurethanes with ionic or mesogenic components, block copolymers of polyethylene terephthalate and polyethylene oxide, block copolymers of polystyrene and poly(1,4-butadiene), ABA triblock copolymers of poly-(2-methyl-2-oxazolin) (A block) and polytetrahydrofuran (B block), multiblock copolymers of polyurethanes with poly(ε-caprolactone) switching segment, block copolymers of polyethylene terephthalate and polyethylene oxide, block copolymers of polystyrene and poly(1,4-butadiene), polyurethane systems whose hard segment forming phase consists of methylenediphenyl diisocyanate (MDI) and a diol, particularly 1,4-butanediol, or a diamine and a switching segment with oligoether base, particularly polytetrahydrofuran or an oligoester, particularly polyethylene adipate, polypropylene adipate, polybutylene adipate, polypentylene adipate or polyhexalene adipate, materials with a hard segment forming phase consisting of toluene-2,4-diisocyanate, MDI, diisocyanates constructed particularly from MDI or hexamethylene diisocyanate in carbodiimide-modified form, and from chain extenders, particularly ethylene glycol, bis(2-hydroxyethyl)hydroquinone or a combination of 2,2-bis(4-hydroxyphenyl)propane and ethylene oxide, whose switching segment determining blocks consist of oligoethers, particularly polyethylene oxide, polypropylene oxide, polytetrahydrofuran or a combination of 2,2-bis(4-hydroxyphenyl)propane and propylene oxide, or of oligoesters, particularly polybutylene adipate, materials from polynorbornene, graft copolymers of polyethylene/nylon-6, block copolymers with polyhedral oligomeric silsesquioxanes (POSS), including the combinations polyurethane/POSS, epoxy/POSS, polysiloxane/POSS, polymethyl methacrylate/POSS, silicone-based SMPs and materials made from poly(cyclooctene).

According to other embodiments, the SMP may be an elastomer SMP, particularly from the group consisting of polyvinyl chloride, polyethylene-polyvinyl acetate copolymers, covalently crosslinked copolymer systems of stearyl acrylate and esters of methacrylic acid.

According to still other embodiments, the SMP may be a nematic liquid crystal elastomer, or even a photodeformation polymer. Such materials may have a two-shape memory and two-way effect.

According to yet other embodiments of the present invention, the SMP is constructed as a shape memory polymer composite. In this context, it should be noted that the terms shape memory polymer and shape memory polymer composite are used interchangeably. In other words, an SMP may be substituted with a correspondingly suitable SMP composite, or vice versa. The term SMP composite is used to refer to materials in which one or more filler materials are embedded in the SMP matrix. Conceivable filler materials in this context may be for example magnetic nanoparticles, ferromagnetic particles, particularly AlN particles, Ni particles, Fe₂O₃ particles, Fe₃O₄ particles, NiZn particles. “Nanoclays” may also be used as filler materials. Such nanoclays may be formed on a basis of silicon nitride, silicon carbide, silicon oxide, zirconium oxide and/or aluminium oxide. Other possible filler materials are oligomeric silsesquioxanes, graphite particles, carbon nanotubes, synthetic fibres, particularly carbon fibres, glass fibres or Kevlar fibres, as well as metal particles, thermochromic materials, particularly rutile, zinc oxide, 9,9′-bixanthylidene, 10,10′-bianthronylidene or bis-diethylammonium tetrachlorocuprate(II), and combinations of these filler materials.

Certain thermochromic materials, particularly inorganic compounds, particularly rutile and zinc oxide, and organic compounds, particularly 9,9′-bixanthylidene and 10,10′-bianthronylidene may also be integrated as an additional identification feature. Another example is the compound bis-diethylammonium tetrachlorocuprate(II), which undergoes a solid-solid phase conversion accompanied with a change in colour from green to yellow at about 53° C. A change in colour may be accompanied by a change in shape, as is the case with Veriflex® for example.

Of course, combinations of such filler materials may also be used. The filler materials lend themselves to the purpose of adjusting the mechanical, electrical, magnetic, optical and/or thermochromic properties of an SMP and to adapting it to a given application.

Thermosensitive, UV-sensitive, or magnetosensitive and electroactive SMPs may be used in safety labels according to the embodiments of the present invention. Optically controllable shape memory polymers are for example butyl acrylates, which crosslink via cinnamic acid groups on their lateral chains under UV light of a certain wavelength and break the bond when irradiated with a different wavelength. Magnetically controllable shape memory polymers may be obtained for example by incorporating finely disperse magnetic nanoparticles of iron oxide for example in the plastic. Such materials are then able to convert the energy of a magnetic field into heat. A desired temperature may then be set with precision in the polymer by adjusting the fraction of nanoparticles and the strength of the magnetic field. Shape memory polymer composites for example with carbon nanotubes may be used as electroactive polymers (EAP).

Further examples of thermoplastic elastomers are multiblock copolymers. Typical multiblock copolymers are compounded from the blocks (macrodiols) consisting of α,ω-diol polymers of poly(ε-caprolactone) (PCL), poly(ethylene glycol) (PEG), poly(pentadecalactone), poly(ethylene oxide), poly(propylene oxide), poly(propylene glycol), poly(tetrahydrofuran), poly(dioxanone), poly(lactide), poly(glycolide) and poly(lactide-ran-glycolide) or α,ω-diol copolymers of the monomers on which the compounds listed above are based, in a molecular weight range Mₙ from 250 to 500,000 g/mol. Two different macrodiols are linked using a suitable bifunctional coupling reagent (in this case an aliphatic or aromatic diisocyanate or diacid chloride or phosgene) to form a thermoplastic elastomer having molecular weights Mₙ in the range from 500 to 50,000,000 g/mol. In a phase-segregated polymer, one phase in each block of the polymer described above may be assigned with at least one thermal transition (glass or melting transition) independently of the other block.

Multiblock copolymers of macrodiols based on pentadecalactone (PDL) and ε-caprolactone (PCL) and a diisocyanate may also be used. The switching temperature—in this case the melting temperature—may be adjusted in the range between about 30 and 55° C. by adjusting the block length of the PCL. The physical crosslinking points for fixing the permanent shape are formed by a second crystalline phase with a melting point in the range from 87-95° C. Blends of multiblock copolymers are also suitable. The transition temperatures may be adjusted precisely by corresponding modification of the mixture ratio.

Polymer networks can also be used to manufacture the security label. Suitable polymer networks feature covalent crosslinking points and at least one switching segment having at least one transition temperature. The covalent crosslinking points determine the permanent shape of the surface profile. In order to produce a covalent polymer network, one of the macrodiols described in the previous section is crosslinked with the aid of a multifunctional coupling reagent. This coupling reagent may be an at least trifunctional, low molecular weight compound or a multifunctional polymer. If the polymer is used, it may be a star polymer having at least three arms, a graft polymer having at least two side chains, a hyper-branched polymer, or a dendritic structure. In both cases, of the low-molecular weight and the polymer compounds, the terminal groups should be capable of reacting with the diols. In this particular case, isocyanate groups (polyurethane networks) may be used for this. In particular, amorphous polyurethane networks of triols and/or tetrols and diisocyanate may be used. Stellate prepolymers such as oligo[(rac-lactate)-co-glycolate]triol or -tetrol are represented by the ring-opening copolymerisation of rac-dilactide and diglycolide in the melt of monomers with hydroxyfunctional initiators with the addition of the catalyst dibutyltin(IV)oxide (DBTO). Ethylene glycol, 1,1,1-tris(hydroxy-methyl)ethane and/or pentaerythrite are used as initiators of the ring-opening polymerisation. Oligo(lactate-co-hydroxycaproate)tetrols and oligo(lactate hydroxyethoxy acetate)tetrols and [oligo(propylene glycol)-block-oligo(rac-lactate)-co-glycolate)]triols are produced in similar manner. Such networks may be obtained simply by reacting the prepolymers with diisocyanate, for example an isomer mixture of 2,2,4- and 2,4,4-trimethylhexane-1,6-diisocyanate (TMDI), in solution, for example in dichloromethane, and subsequent drying.

The macrodiols described in the preceding section may further be functionalised to form corresponding α,ω-divinyl compounds that may be crosslinked thermally or photochemically. This functionalisation preferably allows the macromonomers to be linked covalently through reactions that do not yield any byproducts. This functionalisation is preferably made available by ethylenically unsaturated units, particularly preferably by acrylate groups and methacrylate groups, the latter being most preferable. In this context, the conversion to α,ω-macrodimethacrylates, and/or macrodiacrylates may be conducted in this particular case with the corresponding acid chlorides in the presence of a suitable base. The networks are obtained by crosslinking the terminal group functionalised macromonomers. This crosslinking is achievable by irradiating the melt, comprising the terminal group functionalised macromonomer component and if necessary a low molecular weight comonomer, as will be explained in the following. Suitable process conditions for this are the irradiation of the mixture in the melt, preferably at temperatures in the range from 40 to 100° C., with light preferably having a wavelength of 308 nm. Alternatively, thermal crosslinking is possible if a corresponding initiator system is used.

If the macromonomers described above are crosslinked, networks with a homogeneous structure are obtained if only one kind of macromonomer is used. If two types of monomer are used, networks of the AB type are obtained. Such AB type networks may also be obtained if the functionalised macromonomers are copolymerised with suitable low molecular weight or oligomeric compounds. If the macromonomers are functionalised with acrylate groups or methacrylate groups, suitable copolymerisable compounds include low molecular weight acrylates, methacrylates, diacrylates or dimethacrylates. Preferred compounds of this kind are acrylates such as butyl acrylate or hexyl acrylate, and methacrylates such as methylmethacrylate and hydroxyethylmethacrylate. These compounds, which are copolymerisable with the macromonomers may be present in a quantity from 5 to 70% by weight, particularly in a quantity from 15 to 60% by weight relative to the network of the macromonomer and the low molecular weight compound. The quantities of low molecular weight compound included may be varied by adding corresponding quantities of the compound to the mixture to be crosslinked. The low molecular weight compound is incorporated in the network in a quantity that corresponds to the quantity obtained in the crosslinking mixture.

Networks with different crosslinking densities (or segment lengths) and mechanical properties may be obtained by varying the molar weight of the macrodiols. The macromonomers for covalent crosslinking typically have a molecular weight number average, determined by GPC analysis, from 2000 to 30000 g/mol, preferably from 5000 to 20000 g/mol, and particularly preferably from 7500 to 15000 g/mol. The macromonomers that are to be covalently crosslinked typically have a methacrylate group at both ends of the macromonomer chain. Functionalisation of this kind enables the macromonomers to be crosslinked by simple photoinitiation (irradiation).

The macromonomers are typically polyester macromonomers, especially polyester macromonomers on an ε-caprolactone base. Other possible polyester macromonomers are based on lactide units, glycolide units, p-dioxanone units and mixtures thereof and mixtures with ε-caprolactone units, polyester macromonomers with caprolactone units being particularly typical. Typical polyester macromonomers further include poly(caprolactone-co-glycolide) and poly(caprolactone-co-lactide). The transition temperature may be adjusted by varying the quantity ratio of the comonomers.

The macromonomers used may particularly be polyester, including the crosslinkable terminal groups. One polyester that is typically usable is a polyester on an ε-caprolactone or pentadecalactone base, for which the preceding notes regarding molar weight also apply. Such a polyester macromonomer, functionalised at the ends, preferably with methacrylate groups, may be produced by simple syntheses that are known to one skilled in the art. Regardless of the other essential polymer component of the present invention, these networks exhibit semicrystalline properties and have a melting point of the polyester component (can be determined by DSC measurements) that is determined by the type of polyester component used and is thus controllable thereby. For segments based on caprolactone units, this temperature (Tₘₗ) is known to be between 30 and 60° C. depending on the molar mass of the macromonomer.

One network for which the melting temperature serves as the switching temperature has the macromonomer poly(caprolactone-co-glycolide)-dimethacrylate as its basis. The macromonomer may be used as such or it may be copolymerised with n-butyl acrylate to form the AB network. The permanent shape is determined by covalent crosslinking points. The network features a crystalline phase whose melting temperature may be adjusted precisely for example by adjusting the comonomer ratio of caprolactone to glycolide. n-butyl acrylate may be used as the comonomer I order to optimise the mechanical properties of the layer, for example. Another network in which the glass transition temperature serves as the switching temperature is obtained from an ABA triblock dimethacrylate as the macromonomer with a centre block B of polypropylene oxide and outer blocks A of poly(rac-lactide). The amorphous networks have a very wide switching temperature range.

Networks with two transition temperatures such as interpenetrating networks (IPNs) for example, are suitable for producing security labels with two shapes in their memory. The covalent network is based on poly(caprolactone)dimethacrylate as the macromonomer; the interpenetrating component is a multiblock copolymer consisting of macrodiols based on pentadecalactone (PDL) and ε-caprolactone (PCL) and a diisocyanate. The permanent shape of the material is determined by the covalent crosslinking points. The two transition temperatures—the melting temperatures of the crystalline phases—may each be used as the switching temperature for one of the temporary shapes. The lower switching temperature Tₜᵣₐₙₛ₁ may be adjusted in the range between approximately 30 and 55° C. by varying the block length of the PCL. The upper switching temperature Tₜᵣₐₙₛ₂ is in the range from 87-95° C.

Photosensitive networks may also be used to produce the security label. Suitable photosensitive networks are amorphous and feature covalent crosslinking points that determine the permanent shape. A further feature is a photoreactive component or a unit that is reversibly switchable by light to determine the temporary shape. In the case of the photosensitive polymers, a suitable network is used that contains photosensitive substituents along the length of the amorphous chain segments. Under UV irradiation, these groups are able to form covalent bonds with each other. If the material is deformed and irradiated with light having a suitable wavelength λ₁, the original network is also crosslinked. This crosslinking means that the material is fixed temporarily in the deformed state (programming). Since photo-crosslinking is reversible, the crosslinking may be cancelled again, thus enabling the material to revert to its original shape, by irradiating again, with light that has a different wavelength λ₂. Such a photomechanical cycle may be repeated any number of times. The basis for the photosensitive materials is a wide-meshed polymer network that, as described in the foregoing, is transparent with regard to the radiation that is intended to trigger the shape change, that is to say it preferably forms a UV-transparent matrix. Typical are networks based on low molecular weight acrylates and methacrylates that are radically polymerisable, particularly C₁-C₆-(meth)acrylates and hydroxy derivatives, wherein hydroxyethyl acrylate, hydroxypropyl methacrylate, hydroxypropyl acrylate, poly(ethylene glycol)methacrylate and n-butyl acrylate, and particularly n-butyl acrylate and hydroxyethyl methacrylate may be used.

A component that is responsible for crosslinking the segments is used as the comonomer for producing the polymer networks. Of course, the chemical nature of this component depends on the nature of the monomers. Suitable crosslinking agents for the networks based on the acrylate monomers described in the preceding are bifunctional acrylate compounds that are appropriately reactive with the starter materials for the chain segments, so that they may be converted together. Crosslinking agents of such kind include short, bifunctional crosslinking agents such as ethylene diacrylate, low molecular weight bi- or polyfunctional crosslinking agents, oligomeric, linear diacrylate crosslinking agents such as poly(oxyethylene)diacrylates or poly(oxypropylene)diacrylates, and branched oligomers or polymers with acrylate terminal groups. The network also contains a photoreactive component (group) that is jointly responsible for inducing the precisely controllable shape change as a further component. This photoreactive group is a unit that is capable of a reversible reaction (with a second photoreactive group) when stimulated by appropriate light irradiation, typically UV irradiation, which causes the creation or breakdown of covalent bonds. Typical photoreactive groups are those that are capable of reversible photodimerization. Typically, various cinnamic acid esters (cinnamates, CA) and cinnamyl acyl acid esters (cinnamyl acylates CAA) are used as photoreactive components in the photosensitive networks.

Cinnamic acid and its derivatives dimerize in UV light at about 300 nm to form a cyclobutane. The dimmers can be split again by irradiating them with UV light of a smaller wavelength, of about 240 nm. The absorption maxima can be shifted on the phenyl ring by substituents, but they always remain in the UV range. Other derivatives that can be photodimerized are 1,3-diphenyl-2-propene-1-one (chalkon), cinnamyl acyl acid, 4-methyl coumarin and various ortho-substituted cinnamic acids, cinammyl oxysilanes (silyl ether of cinnamon alcohol).

The photodimerization of cinnamic acid and similar derivatives is a [2+2] cycloaddition of the dual bonds to produce a cyclobutane derivative. Both the E- and the Z-isomers are capable of participating in this reaction. During irradiation, the E/Z-isomerization competes with the cycloaddition. In the crystalline state, however, the E/Z-isomerization is suppressed. The various arrangement possibilities of the isomers relative to each other mean that theoretically 11 different stereoisomer products are possible (truxillic acids, truxinic acids). The distance between the dual bonds of two cinnamic acid groups necessary for the reaction is about 4 Å.

In the following text, various options for programming the SMPs described in the foregoing will be explained. Individual programming steps may also be transposed if required in order to adapt the programming to specific requirements.

FIGS. 2A to 2D show the basic principle of programming a thermosensitive SMP layer 100. In this, layer 110 is first heated to above the switching temperature Tₜᵣₐₙₛ using a Peltier element 130 for example. In a following step, a surface profile is embossed in surface 112 of layer 110 by means of a stamp 10. At the same time, layer 110 is cooled to below crystallization temperature T_{c} by means of Peltier element 130 in order to fix the surface profile in layer 110. FIG. 2C shows the state in which surface profile 15 is fixed in surface 112 of layer 110. If layer 110 is then heated up again, it reverts to its original state (FIG. 2D), and the programmed surface profile remains stored for subsequent recall.

An alternative variation of the programming of a thermosensitive SMP layer 100 is shown in FIGS. 6A to 6D. Unlike the embodiment shown in FIG. 2, in this case a laser 20 is used to generate the permanent shape of SMP layer 100. Nd:YAG lasers (colour lasers) or CO₂ lasers for example are suitable for processing platelike SMP layer 100, as it is delivered by the manufacturer for example, the CO₂ laser being particularly suitable. A laser beam 22 is generated by laser 20, and is used to structure surface 112 of polymer 110 (FIG. 6B). Additionally, polymer 110 may also be trimmed to a desired shape with the aid of laser 20. The depth of the engraving may be optimised by varying the laser power. For example, a polymer surface are of about 400 mm×300 mm may be processed with an achievable resolution of 100 dpi to 1000 dpi. The information that is to be embossed in SMP layer 110 may be supplied for example as a QR code or a data matrix code. This information may then be engraved with the aid of laser 20 in surface 112 of SMP layer 110, where it is present as a recess 25 (FIG. 6C). Alternatively, the security label may be marked for example with barcodes, logos or the like. As was explained with reference to FIG. 2D, the marking this then rendered undetectable (FIG. 6D). The layer thickness remaining after this is less than the layer thickness in the permanent shape. This is illustrated by the dashed lines in FIG. 6. When the shape memory effect is triggered subsequently, the surface resumes its permanent shape, and the marking, for example a QR code or a data matrix code, may be read out with the aid of a data matrix test device.

In the following, the programming of SMPs with two-shape memory and one-way effect and SMPs with two-shape memory and two-way effect will be explained with reference to FIG. 3. In order to create an image in an SMP surface as an identification feature, the SMP label may be heated up to a temperature that is higher than its switching temperature (step 310), wherein the switching temperature may be a glass transition temperature or a melting temperature of crystalline segments of the SMP. In this way, the SMP label may be prepared for storing a three-dimensional profile.

Alternatively, SMPs may be irradiated with UV light, which causes the crosslinking bonds in the SMP to break down. Then, the three-dimensional surface structure may be embossed in the SMP layer (step 320), after which this three-dimensional surface structure is fixed in the layer (step 330). This may be carried out for example by cooling the SMP layer to below a glass transition temperature or below a crystallization temperature of the SMP, in which case the embossing pressure applied to SMP surface must be maintained while the layer cools down. Alternatively, certain SMPs may be irradiated with UV light, which induces crosslinking in the SMP. After the shape memory transition is recalled (step 340), the SMP layer is in its original state again, in which it has an essentially flat surface. In one embodiment, this is achieved by heating it to above the switching temperature of the SMP, for example by applying an electric voltage or a magnetic field. In another embodiment, the SMP layer is switched to its starting state by irradiation with UV light.

An alternative programming method is shown in FIG. 4, in which a sequence of letters is embossed in an SMP in the highly viscous melt. After the melt is cooled to room temperature, a thermosensitive SMP for example may be fixed in a temporary shape by applying a load at T>Tₜᵣₐₙₛ and subsequently cooling to below T<T_{g} or T<T_{c} and maintaining the load. The force necessary to create this deformation depends both on the hardness of the SMP and on the ambient temperature. The deformation this causes renders the letter sequence unrecognisable; it only becomes clearly visible again when the shape memory effect is induced by heating.

According to FIG. 4, in step 410 first the SMP is provided in the melt and it is then immediately embossed with the desired information using a stamping tool (step 420). Then, in step 430 the layer is cooled to room temperature RT in order to define the permanent shape of the SMP. In the next step 440, the SMP layer is heated to above Tₜᵣₐₙₛ and smoothed by means of a superimposed load. In this embodiment, therefore, the flat surface actually corresponds to the embossed temporary shape. Then in step 450 the temporary shape is fixed by cooling the layer to below T_{g} or T_{c}. Now the layer only needs to be heated up to above Tₜᵣₐₙₛ again (step 460) in order to read out the stored surface information.

For many SMPs, the shape recall is triggered by exceeding a “switching temperature”. Among these thermosensitive SMPs, a distinction may generally be made between SMPs for which the switching temperature corresponds to a glass transition (Tₜᵣₐₙₛ=T_{g}) and SMPs for which the switching temperature corresponds to the melting temperature of crystalline soft segments (Tₜᵣₐₙₛ=Tₘ). In the latter case, the SMPs include two components, a first component being a hard segment, and the second component being a soft segment. If the SMP is deformed, the elastic SMP is frozen in its deformed state by the hard segments and the crystallisation of amorphous soft segments. If the SMP is then heated up, the crystalline soft segments thaw out and lend the SMP a restoring force that acts against the programming direction. At the end of the shape memory transition, the SMP is restored to its original shape again.

In both cases, the programming is carried out by deforming the polymer material above the switching temperature of a switching segment and then by cooling to below this temperature (in the case of Tₜᵣₐₙₛ=T_{g}) or below the crystallisation temperature (Tₜᵣₐₙₛ=T_{c}) while maintaining the deformation forces to fix the temporary shape. Heating it to above the switching temperature (Tₜᵣₐₙₛ=T_{g} or Tₘ) again results in a phase transition and the restoration of its original shape.

Alternatively to thermally indexed shape recovery, this may also be effected by irradiation with UV light, the influence of a magnetic field or the application of a voltage if the label is an SMP composite.

In the case of SMPs with two-shape memory and two-way effect, it is sufficient to emboss a temporary shape above Tₘ and to fix it by cooling to a temperature below T_{c}, in order to trigger mechanical activity when the SMP is heated and cooled again. An example of a compound with a two-shape memory and two-way effect is poly(cyclooctene), which is marketed by Evonik Degussa GmbH under the tradename Vestenamer®. In addition, some nematic liquid crystal elastomers and photodeformation polymers also exhibit the reversible two-way effect when they are heated/cooled.

A production method and a read-out method for a security label with SMPs having a three-shape memory and one-way effect are described with reference to FIG. 5. Similarly to the method described in the preceding, for example a lettering may be embossed in an SMP present in the highly viscous melt (steps 510 and 520). After the melt has cooled to room temperature for example (step 530), for example a thermosensitive SMP may be fixed in a temporary shape (step 540) by applying a load at T>Tₘ and subsequently cooling it to below T<T_{c} while maintaining the load (punching tool 1). For example, the deformation that takes place in the embodiment renders the lettering “CODE” unrecognisable. A further deformation at T<T_{c} and subsequent cooling to T<T_{g} then result in the fixing of a second shape (step 550), in which the surface structure of punching tool 2 is embossed. Now the security label is doubly programmed. In a subsequent read-out operation, layer 110 is heated up to T>T_{g} (step 560), which results in the recovery of the first temporary shape. Further heating to T>Tₘ (step 570) then leads to recovery of the permanent shape.

Alternatively, a flat permanent shape may serve as the starting point. In this case, the punching tool is not used for embossing in the polymer melt (steps 510 to 530). The embossed designs shown in FIG. 5 are freely selectable according to the stamping tools.

According to another embodiment, a security label for identifying a product comprises a layer with a shape memory polymer, wherein in a first state the layer has a first surface profile that contains information for identifying the product. This first state is typically the permanent shape of the SMP layer. Here the SMP layer may be brought into a permanent shape that has the desired surface structure for example when a security label is manufactured with conventional processing methods such as injection moulding. Experiments have shown that the surface of both thermoplastic and thermosetting materials with SM properties may be structured easily by mechanical or chemical methods, for example by grinding, etching or similar, after processing has taken place. In the following, production methods are described that are suitable for example for thermoplastics (such as poly(ester urethanes)), because these enable the direct production of the SMP layer in its permanent shape. According to a first embodiment, the SMP is dissolved in a common solvent such as tetrahydrofuran, and then evaporated in a template especially produced for this purpose. In one example, it was demonstrated that about 200 mg poly(ester urethane) is dissolved in 5 ml tetrahydrofuran and that the foil obtained after the solvent has evaporated had the desired shape memory properties. According to a further embodiment, a shape memory layer may be obtained with the desired surface profile as the permanent shape by fusing the SMP directly in a vacuum drying cabinet and casting it into a template. In this context, the fusion and casting were carried out at about 240° C. and 20 mbar. The SMP layers obtained in this way had practically identical shape memory properties with the starting material. According to a further embodiment, the surface profile is created by mechanical action. According to yet another embodiment, the surface profile is created by chemical etching with strong acids (for example conc. HCl) or strong bases (NaOH, 1 molar). For thermoplastic and/or thermosetting materials, mechanical or chemical marking appears to be an alternative to laser engraving.

The SMP layer may also assume at least a second state, wherein the layer has a second surface profile in the second state, and this is different from the first surface profile. For example, in a programming step the SMP layer is heated up to a temperature above switching temperature Tₜᵣₐₙₛ, deformed by a compressive or tensile force, and fixed by cooling to below the shape fixing temperature (glass transition temperature T_{g} or crystallisation temperature T_{c}). In one embodiment, the SMP layer has a flat surface in the second state, so that the permanent shape is not detectable for an observer. According to another embodiment, that second surface profile may also be structured such that the second surface profile contains different information than the first surface profile. This second set of information may serve for example to mislead counterfeiters.

The temporary shape of the second surface profile is stored until the shape memory effect is triggered thermally by exceeding Tₜᵣₐₙₛ. The security label is therefore adapted such that the SMP layer is switched from the second state into the first state to allow the security label to be read out.

The permanent shape may be restored during production of the security label for quality control purposes. If such an operation reveals that the information cannot be recovered in good enough quality, the permanent shape may be restructured and/or the temporary shape of the material may be programmed again.

In the following, this is represented in FIG. 7 for a thermosetting SMP, specifically Standard Veriflex® manufactured by CRG Industries. FIG. 7 shows image sequences of Veriflex® surfaces following mechanical pretreatment (left, permanent shape), after programming with the second, smooth surface structure (centre, temporary shape), and after restoration to the permanent shape by heating to above Tₜᵣₐₙₛ (right, permanent shape). Here, Veriflex® has a transition temperature of Tₜᵣₐₙₛ=T_{g}=62° C. This clearly shows that the permanent shape is restored almost perfectly.

FIG. 8 shows examples to illustrate the fact that the temporary shape does not necessarily have to have a smooth surface. As was described previously, an additional identification that is only detectable in the temporary shape may also be programmed temporarily, thereby creating the appearance that a marking already exists, that is to say the one that is discernible in the temporary shape. In FIG. 8, the permanent shapes (first surface profile) of Veriflex® layers are shown on the left. The middle column of FIG. 8 shows the temporary surface after programming with a 2-point stamp (centre, temporary shape) and after heating (right, recovered permanent shape).

The property that enables SMPs to be modified easily by mechanical means in their permanent shape without any subsequent visual deterioration in the shape memory property is important for the functionality of security labels, since this enables the embossed, security critical information to be recalled and rendered invisible again repeatedly. FIG. 9 shows five consecutive cycles, including a programming and a shape recovery step which were processed in sequence one after the other. Here to, the illustration shows a view of the surface of a Veriflex® layer.

It should also be noted that the SMP may be manufactured not only in strip or layer form, but also in other forms, for example as a sphere. Casting moulds enable spheres to be produced with diameters from 1 mm up to several centimetres. Other geometrical shapes are also possible, including for example triangles, pyramids, prisms, octahedral, dodecahedra and/or other polyhedral are conceivable.

The present invention has been explained with reference to embodiments thereof. These embodiments are not to be construed as limiting the present invention in any way. In particular, individual features of the various embodiments may be incorporated into other variations, or various embodiments may be combined with each other provided the features combined do not render each other technically unfeasible.

1. Security label for identifying products, comprising
a layer (110) including a shape memory polymer, wherein in the first state the layer (110) has a first surface profile (15, 25) that contains information for identifying the product, and wherein the layer can assume at least a second state, wherein in the second state the layer has a second surface profile that is different from the first surface profile
wherein the security label is adapted such that the layer (110) is switchable from the second state to the first state for reading out the security label, and
a joining means for joining the layer to the product.

2. The security label as recited in claim 1, wherein the first surface profile is the permanent shape of the shape memory polymer layer.

3. The security label as recited in claim 1, wherein the second surface profile is generated by programming the shape memory polymer layer.

4. The security label as recited in claim 1, wherein the second surface profile is a flat surface.

5-19. (canceled)

20. The security label as recited in claim 1, wherein the layer has a thickness in the range from 0.1 mm to 20 mm.

21. The security label as recited in claim 1, wherein the shape memory polymer is constructed as a shape memory polymer composite, wherein at least one filler material is embedded in the shape memory polymer matrix and is selected from the group that includes: magnetic nanoparticles, ferromagnetic particles, particularly AlN particles, Ni particles, Fe2O3 particles, Fe3O4 particles, NiZn particles, a nanoclay containing silicon nitride, silicon carbide, silicon dioxide, zirconium oxide and/or aluminium oxide, oligomeric silsesquioxanes, graphite particles, carbon nanotubes, synthetic fibres, particularly carbon fibres, glass fibres or Kevlar fibres, metal particles, thermochromic materials, particularly rutile, zinc oxide, 9,9′-bixanthylidene, 10,10′-bianthronylidene or bis-diethylammonium tetrachlorocuprate(II), and combinations of these filler materials.

22. The security label as recited in claim 1, wherein the shape memory polymer is selected from the group consisting of: a poly(ester urethane) copolymer, a nematic liquid crystal elastomer, and a photodeformation polymer.

23. A security label for identifying a product, comprising
a layer including a shape memory polymer, wherein a surface profile containing information for identifying the product is embossed in the layer, and
wherein the layer can assume at least a first and a second state, wherein in the first state the layer has a flat surface and in the second state the layer has an embossed surface profile,
wherein the security label is adapted such that the layer is switchable from the first or second state to the second or first state respectively for reading out the security label, and
a joining means for joining the layer to the product.

24. The security label as recited in claim 23, wherein a second surface profile is also embossed in the layer, and wherein in a third state the layer has the embossed second surface profile,
wherein the security label is adapted such that the layer can be brought from the first or third state to the third or first state respectively for reading out the security label.

25. The security label as recited in claim 24, wherein the security label is set up so that the label is brought into the first state from the second state and/or the third state.

26. The security label as recited in claim 23, wherein the layer has a thickness in the range from 0.1 mm to 20 mm.

27. The security label as recited in claim 23, wherein the shape memory polymer is selected from the group including: linear block copolymers, particularly polyurethanes and polyurethanes with ionic or mesogenic components, block copolymers of polyethylene terephthalate and polyethylene oxide, block copolymers of polystyrene and poly(1,4-butadiene), ABA triblock copolymers of poly(2-methyl-2-oxazolin) (A block) and polytetrahydrofuran (B block), multiblock copolymers of polyurethanes with poly(ε-caprolactone) switching segment, block copolymers of polyethylene terephthalate and polyethylene oxide, block copolymers of polystyrene and poly(1,4-butadiene), polyurethane systems whose hard segment forming phase consists of methylenediphenyl diisocyanate (MDI) and a diol, particularly 1,4-butanediol, or a diamine and a switching segment with oligoether base, particularly polytetrahydrofuran or an oligoester, particularly polyethylene adipate, polypropylene adipate, polybutylene adipate, polypentylene adipate or polyhexalene adipate, materials with a hard segment forming phase consisting of toluene-2,4-diisocyanate, MDI, diisocyanates constructed particularly from MDI or hexamethylene diisocyanate in carbodiimide-modified form, and from chain extenders, particularly ethylene glycol, bis(2-hydroxyethyl)hydroquinone or a combination of 2,2-bis(4-hydroxyphenyl)propane and ethylene oxide, whose switching segment determining blocks consist of oligoethers, particularly polyethylene oxide, polypropylene oxide, polytetrahydrofuran or a combination of 2,2-bis(4-hydroxyphenyl)propane and propylene oxide, or oligoesters, particularly polybutylene adipate, materials from polynorbornene, graft copolymers of polyethylene/nylon-6, block copolymers with polyhedral oligomeric silsesquioxanes (POSS), including the combinations polyurethane/POSS, epoxy/POSS, polysiloxane/POSS, polymethyl methacrylate/POSS, silicone-based SMPs and materials made from poly(cyclooctene)ε-caprolactone.

28. The security label as recited in claim 23, wherein the shape memory polymer is selected from the group consisting of: polyvinyl chloride, polyethylene-polyvinyl acetate copolymers, covalently crosslinked copolymer systems of stearyl acrylate and esters of methacrylic acid, trans-polyisoprene/polyurethane-based, segregated SMP, poly(ether ester) such as polyethylene oxide)/poly(ethylene terephthalate) copolymers, norbornyl/POSS copolymers, poly(methylene-1,3-cyclopentane) and copolymers thereof with polyethylene, styrene/butadiene copolymers, thiol-ene/acrylate copolymers, polynorbornene, polymer networks produced from poly(ε-caprolactone) (PCL) and dimethacrylates, poly(ε-caprolactone) (PCL)-based SMPs, acrylate-based SMPs, (meth)acrylate networks, crosslinked polyethylene, epoxy-based SMPs, a polyurethane/phenoxy blend, a polyurethane/polyvinyl chloride (PVC) blend.

29. The security label as recited in claim 23, wherein the shape memory polymer is constructed as a shape memory polymer composite, wherein at least one filler material is embedded in the shape memory polymer matrix and is selected from the group that includes: magnetic nanoparticles, ferromagnetic particles, particularly AN particles, Ni particles, Fe2O3 particles, Fe3O4 particles, NiZn particles, a nanoclay containing silicon nitride, silicon carbide, silicon dioxide, zirconium oxide and/or aluminium oxide, oligomeric silsesquioxanes, graphite particles, carbon nanotubes, synthetic fibres, particularly carbon fibres, glass fibres or Kevlar fibres, metal particles, thermochromic materials, particularly rutile, zinc oxide, 9,9′-bixanthylidene, 10,10′-bianthronylidene or bis-diethylammonium tetrachlorocuprate(II), and combinations of these filler materials.

30. The security label as recited in claim 23, wherein the shape memory polymer is selected from the group comprising: a poly(ester urethane) copolymer, a nematic liquid crystal elastomer, a photodeformation polymer.

31. A product comprising a security label as recited in claim 23.

32. Use of a security label as recited in claim 23 for identifying a product.

33. Method for producing a security label for a product as recited in claim 23, comprising
heating the shape memory polymer layer to above a switching temperature of the shape memory polymer,
embossing a three-dimensional surface structure that contains the identifying information for the product into the shape memory polymer layer, and
cooling the shape memory polymer layer to below a fixing temperature of the shape memory polymer to return the shape memory polymer layer to its first state.

34. Method for producing a security label for a product as recited in claim 1, comprising
generating a first three-dimensional surface structure that contains information for identifying the product as a permanent shape of the shape memory polymer layer,
heating the shape memory polymer layer to above a switching temperature of the shape memory polymer,
programming a second three-dimensional surface structure, and
cooling the shape memory polymer layer to below a fixing temperature of the shape memory polymer to fix the second three-dimensional surface structure.

35. Method for reading out a security label for a product, comprising providing a security label as recited in claim 1,
heating the security label to above a switching temperature of the shape memory polymer so that the embossed, three-dimensional surface structure containing the information for identifying the product appears, and
reading out the information relating to the product stored in the three-dimensional surface structure.

36. Method for producing a security label as recited in claim 1, including providing a shape memory polymer layer that comprises ad first and a second switching temperature, wherein the first switching temperature is higher than the second switching temperature,
heating the shape memory polymer layer to a temperature above the first switching temperature of the shape memory polymer,
embossing a first three-dimensional surface structure that contains information for identifying a product into the shape memory polymer layer,
cooling the shape memory polymer layer to below a first fixing temperature of the shape memory polymer, which is between the first and second switching temperatures, to fix the first surface structure,
embossing a second three-dimensional surface structure that contains second information for identifying a product into the shape memory polymer layer at a temperature that is higher than the second switching temperature, and
cooling the shape memory polymer layer to below a second fixing temperature of the shape memory polymer, which is lower than the second switching temperature, to fix the second surface structure.

37. A method for reading out a security label for a product, comprising provision of a security label as recited in claim 1,
heating the security label to above the second switching temperature of the shape memory polymer, so that a second three-dimensional surface structure appears,
reading out the information relating to the product stored in the second three-dimensional surface structure,
heating the security label to above a first switching temperature of the shape memory polymer, so that an embossed first three-dimensional surface structure appears, and
reading out the information relating to the product stored in the first three-dimensional surface structure.
